(19) United States
(12) Patent Application Publication
(10) Pub. No.: US 2019/0347856 A1
(43) Pub. Date: Nov. 14, 2019

(54) Affixing Digital Content to Physical Objects in Augmented Reality

(71) Applicant: Jong Shyr Huang, Redmond, WA (US)

(72) Inventor: Jong Shyr Huang, Redmond, WA (US)

(21) Appl. No.: 15/974,925

(22) Filed: May 9, 2018

(51) Int. Cl. G06T 19/00; G06T 19/20; G06K 9/00; G06K 7/14; H04W 4/18

(52) U.S. Cl. CPC G06T 19/006; G06T 19/20; H04W 4/185; G06K 7/1417; G06K 9/00671

(57) ABSTRACT

A method and system are provided for affixing digital content to physical objects in Augmented Reality. A user in Augmented Reality view can attach digital content to any physical object in sight by touching the object of interest. The digital content's three-dimensional coordinate in Augmented Reality coordinate system is converted to a real-world coordinate represented by latitude, longitude, and height. All digital content with its meta data such as GPS location, height, and Geographic Context are stored on the servers for subsequent retrieval. To vastly improve the accuracy of placement of digital content in the Augmented Reality view, a reference point with known GPS locations is used as starting origin of Augmented Reality coordinate system. A QR code, associated with a reference point and height, is used to facilitate fast and consistent positioning of origin of the Augmented Reality.

### CROSS-REFERENCE TO RELATED APPLICATION

Not applicable.

### STATEMENT REGARDING FEDERALLY SPONSORED RESEARCH OR DEVELOPMENT

Not applicable.

### FIELD OF THE INVENTION

The present invention relates to techniques for creation and retrieval of digital content attached to physical objects in Augmented Reality using mobile devices with Global Positioning System (GPS) and Internet connection.

### BACKGROUND OF THE INVENTION

With the advent of smart phones, tablets, and mobile devices, capturing digital content such as images, videos, and sound via built-in camera and microphone becomes easy. Furthermore, with built-in GPS, the device knows our geographic location. As a result, every image, video, and sound captured by smart phones and similar devices already contain GPS locations. A smart phone or a similarly equipped device now becomes a very efficient tool for digital content acquisition and creation. In this invention, a user can create digital content that contain text, audio, videos, and photos with a smart phone equipped with GPS and Internet connection. All digital content created will be tagged with GPS locations.

Modern databases such as MongoDB, SQL, and Elasticsearch provide content store capabilities to store, index, and retrieve digital content. They not only index digital content by text but also by geographic locations represented by longitude and latitude. Furthermore, these modern databases allow spatial searches where digital content can be filtered by a geographic area indicated by a bounding polygon or circle. An embodiment of this invention contains a content store for storing, indexing, and retrieving digital content by bounding geographical area represented by either a polygon or circle.

Augmented Reality is a technology that superimposes a computer-generated perpetual information on a user's view of the real world, thus providing a composite view. A multitude of mobile device operating systems, such as iOS from Apple Inc., and Android from Google Inc., now provides software libraries to facilitate the creation of Augmented Reality view on their supported mobile devices. An embodiment of this invention uses the Augmented Reality view provided by iOS and Android on a smart phone.

An Augmented Reality view maintains a virtual three-dimensional (3D) coordinate system of the world as the user looks around via the camera. By rendering digital content on this coordinate system, and overlaying this system over the live images from the camera, the effect of “Augmented Reality” is produced.

Although an Augmented Reality view has its own 3D coordinate system where all digital content's positions are represented therein. The origin of the Augmented Reality view's coordinate system is the position of the mobile device when Augmented Reality view was started. The recall of the digital content in its correct positions lies in the ability to start the Augmented Reality view at exactly the same origin when the digital content was created. Currently, there is no way to recreate the Augmented Reality environment to position digital content accurately on physical objects. Although there were attempts to use a user's GPS location to show digital content in Augmented Reality view. The GPS location of user can be off by up to 10 meters. This amount of inaccuracy can not provide reliable digital content positioning on physical objects in a small area such as a room in a house.

This invention aims to use Quick Response (QR) code to position a mobile device as the user switches into Augmented Reality view. The QR code has a predetermined size, say 1-inch square and is placed at a predetermined height, say 55 inches, with an optional GPS location represented by latitude and longitude. By fitting the QR code in a focus rectangle in the QR code scanner view, we have a way to position the origin of the Augmented Reality view consistently. If the user starts the Augmented Reality view by first scanning the QR code, all digital content will be positioned correctly in the Augmented Reality view's 3D coordinate space.

### SUMMARY OF THE INVENTION

In one aspect, this invention includes a smart phone, glasses, or similar mobile device that is equipped with Internet data service, and Global Positioning System (GPS.) The smart phone, glasses or similar mobile device contains a user application that allows the user to create digital content, such as forms, reference points, or documents on a map based on GPS location. The system also includes an Internet-based Application Programming Interface (API) layer on a server that provides the service endpoints for the user-application running on the smart phone or similar mobile device. Behind the API layer is the content store for storing and indexing digital content and meta data such as GPS location, Geographic Context and content height.

In another aspect, this invention includes a user application running on a smart phone or similar mobile device. The user application allows the user to partition a region into areas and subareas in a Map view. The hierarchical containment relationships among areas constitutes Geographic Context like folder and file hierarchy in a computer file system. This user application also allows the user to create digital content such as forms, documents, and reference points that are associated with the current GPS location in a Map view.

In yet another aspect, this invention uses a printed QR code that represents a Geographic Path. The Geographic Path is then used to retrieve a reference document from the server that contains a GPS location. This QR code is affixed to a physical structure at a fixed height. The QR code thus represents a GPS location and height from the ground where the user is standing.

In an additional aspect, this invention includes a user application running on a smart phone or similar mobile device. The user application allows the user to activate Augmented Reality view by first scanning a QR code affixed on a physical structure at a fixed height. As soon as the QR code is scanned and recognized by the user application, a Geographic Path is used to retrieve a reference point document with a known GPS location. The QR code determines the origin of the Augmented Reality view's coordinate system. The user can attach digital content to any physical object through the Augmented Reality view by touching the object of interest. The three-dimensional coordinate in the Augmented Reality view is then converted to latitude, longitude, and height, which is saved to the content store on the server for subsequent retrieval.

### BRIEF DESCRIPTION OF THE DRAWINGS

The present invention is described in detail below with references to the attached drawing figures, wherein:

FIG. 1 is an exemplary block diagram showing an embodiment of the invention;

FIG. 2 is an exemplary map showing how a region can be partitioned into areas to create Geographic Context;

FIG. 3 depicts the coordinate system for Augmented Reality;

FIG. 4 demonstrates the mapping between Augmented Reality and Content coordinate systems;

FIG. 5 is an exemplary map showing how a reference point can be created in a Geographic Context;

FIG. 6 is an exemplary QR code affixed to a physical structure at fixed height from the ground level;

FIG. 7 demonstrate how to fit the QR code in a focus rectangle.

### DETAILED DESCRIPTION OF THE INVENTION

The invention relates to a system for creating and retrieving digital content attached to any physical object in Augmented Reality.

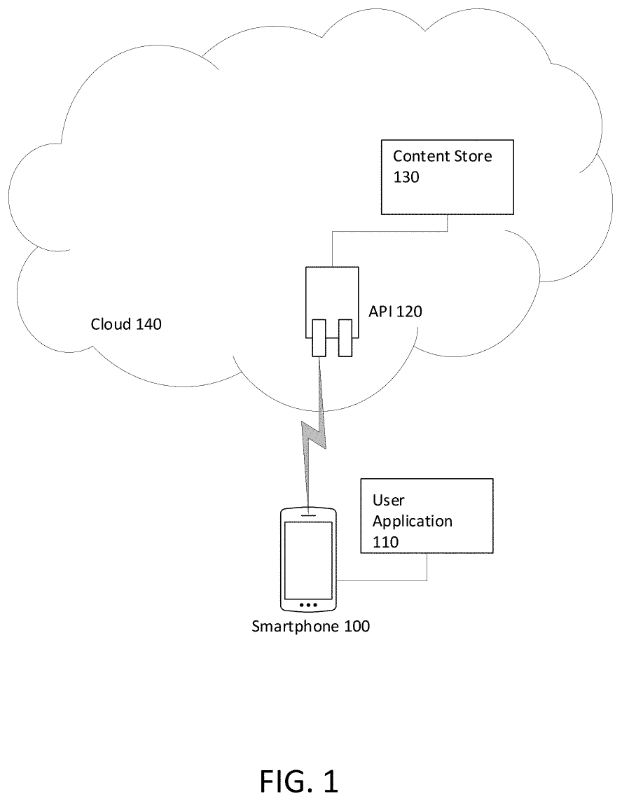

FIG. 1 illustrates an embodiment the invention. Users of this invention will need a mobile device, such as a smartphone 100 with built-in GPS, and Internet connection. The use of GPS is to allow the latitude and longitude of the device to be detected. On this smartphone 100, there is a user application 110 running that has two views—a Map view and an Augmented Reality view. In the Map view, the user can create digital content, such as photos, forms, documents, or reference points, based on the user's current GPS location. In Augmented Reality view, the user can create and view digital content attached to physical objects. The digital content created is sent to the servers in the cloud 140. The digital content to be stored on the servers are received by the Application Programming Interface (API) 120, which is an abstract layer through which the application on user's device communicates with the servers in the cloud 140. All data contained in any digital content are stored at the Content Store 130. All text portion of the digital content and its meta data such as GPS location, and Geographic Context will be indexed by the Content Store 130. All queries from the user application 110 will be done through the API 120 and directed to the Content Store 130.

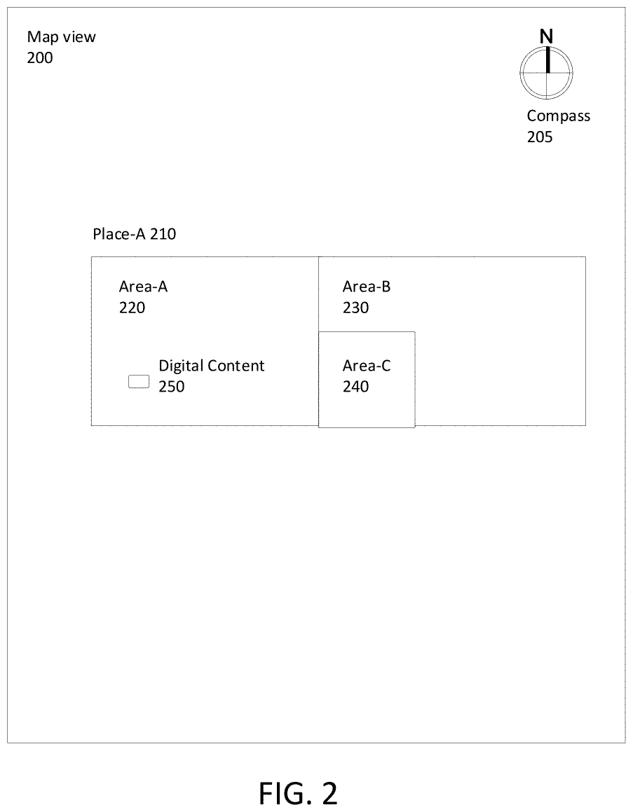

To minimize the number of digital content to display in both Map and Augmented Reality views, this invention allows the user to divide an area on the map into subareas. FIG. 2 is an embodiment of a Map view 200 with a compass 205 that points to the north. An exemplary region of interest, Place-A 210 is divided into two areas Area-A 220, and Area-B 230. Area-B in turn has a subarea called Area-C 240. When a user creates a digital content 250 in Area-A 220, this invention not only stores the GPS location but also the Geographic Context Place-A/Area-A with all data contained in digital content 250 to the Content Store for storage and indexing. This allows the invention to show only relevant digital content depending on the user's current GPS location and Geographic Context.

In the user application 110 (FIG. 1), a user can traverse the hierarchy of Geographic Context much like traversing a folder and file hierarchy in a file system. As a user move into an area such as Area-A 220, the use application 110 will query the Content Store 130 (FIG. 1) for all digital content within the Geographic Context Place-A/Area-A. This invention uses Geographic Context to limit the amount of digital content visible in Augmented Reality view so that a user will not be overwhelmed by a vast amount of content.

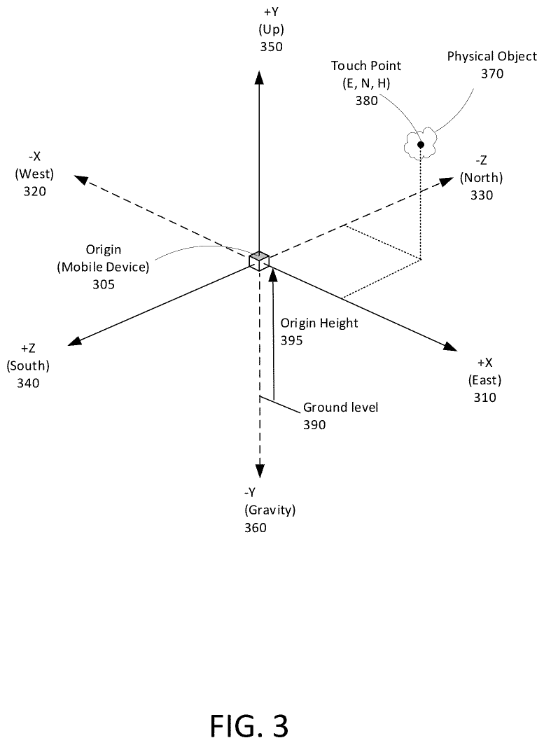

To attach digital content to any physical object requires the user to be in the Augmented Reality view provided by the user application 110 (FIG. 1.) From the Augmented Reality view, the user can see the physical objects through the live video camera on the mobile device. All physical objects are positioned in an Augmented Reality coordinate system, which is depicted in FIG. 3. The Origin 305 is determined by the position of the mobile device when the user started the Augmented Reality view. The X axis points to the east and west direction where positive values +X 310 points to the east. The Z axis points to the north and south direction where positive values +Z 340 points to the south. The Y axis is the vertical axis where positive values +Y 350 points upward. When the user sees a physical object 370 through the video camera, the user can touch the object in the Augmented Reality view. The Touch Point 380 has a position represented by (E, N, H), where E is distance from Origin 305 on the X axis, N is a distance from Origin 305 on the Z axis and H is the height. All values are in meters. Using the coordinate of the Touch Point 380 as the center coordinate of digital content, the digital content is then attached to Physical Object 370.

In FIG. 3, the coordinate of the Touch Point 380 was calculated based on the Origin 305, which is the position of the mobile device when it launched the Augmented Reality view. The Origin 305 will be different each time a user turns on the mobile device. That means position off the Touch Point 380 will be different, and the digital content displayed at the Touch Point 380 position will not be on the intended physical object 370. Therefore, the key to affixing digital content to physical objects lies in the ability to position the Origin 305 of the Augmented Reality Coordinate System consistently with little error. This invention uses GPS location, which consists of latitude and longitude to position the two-dimensional position of Origin 305 to a point on our Earth's surface. In addition, this invention uses the Origin Height 395, which is the height of the Origin 305, in meter, above Ground Level 390 as the third dimension. The use of GPS location and height above ground will then become a reference point for Origin 305.

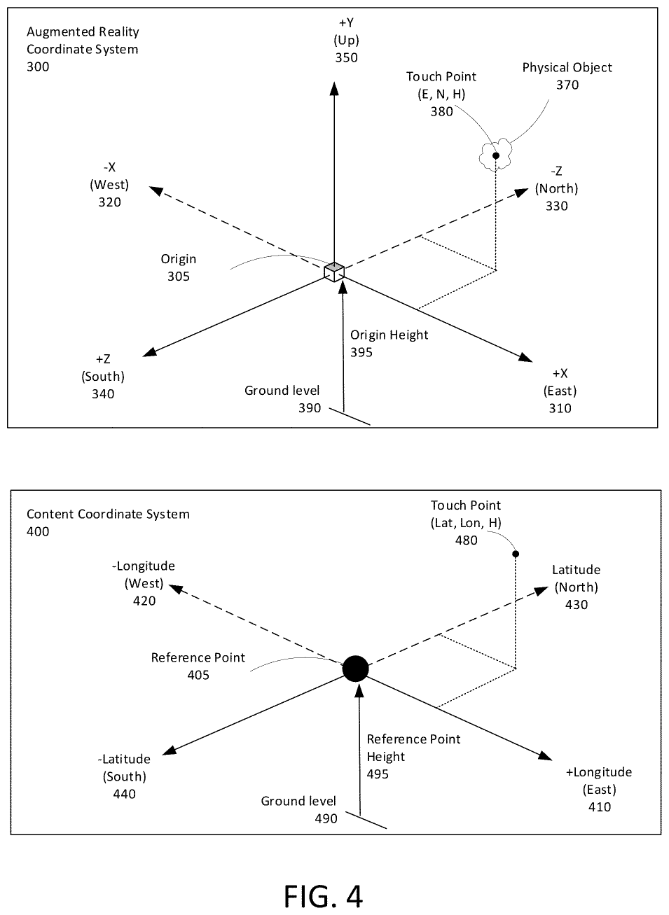

In FIG. 4, by mapping the Origin 305 of the Augmented Reality Coordinate System 300 to a Reference Point 405 with known GPS location plus height, this invention can convert coordinates of all digital content from Augmented Reality Coordinate System 300 to Content Coordinate System 400. For example, when a user touches a Physical Object 370, a three-dimensional coordinate (E, N, H) is generated for Touch Point 380, where E, N, H are meters in distance away from Origin 305. We can convert this coordinate (E, N, H) into a coordinate (Lat, Lon, H) in Content Coordinate System 400. Assuming the coordinate for the Reference Point 405 is (Lat₀, Lon₀, H₀), we can easily calculate the Touch Point 480 coordinate (Lat, Lon, H) by moving GPS location (Lat₀, Lon₀) of Reference Point 405 first to the east by E meters with a bearing of 90 degrees; then to the north by N meters with a bearing of 0 degree, where bearing is the angle between the North with the travel direction. The calculations are supported by several common libraries such as Google Map API. H is the same in both coordinate systems. All digital content and the Reference Point 405 are tagged with 3D coordinates in Content Coordinate System in the form of (Latitude, Longitude, Height) and stored in the Content Store. When viewing in the Augmented Reality view, all coordinates of digital content and the Reference Point 405 will be converted back to the Augmented Reality Coordinate System before they are displayed in the Augmented Reality view.

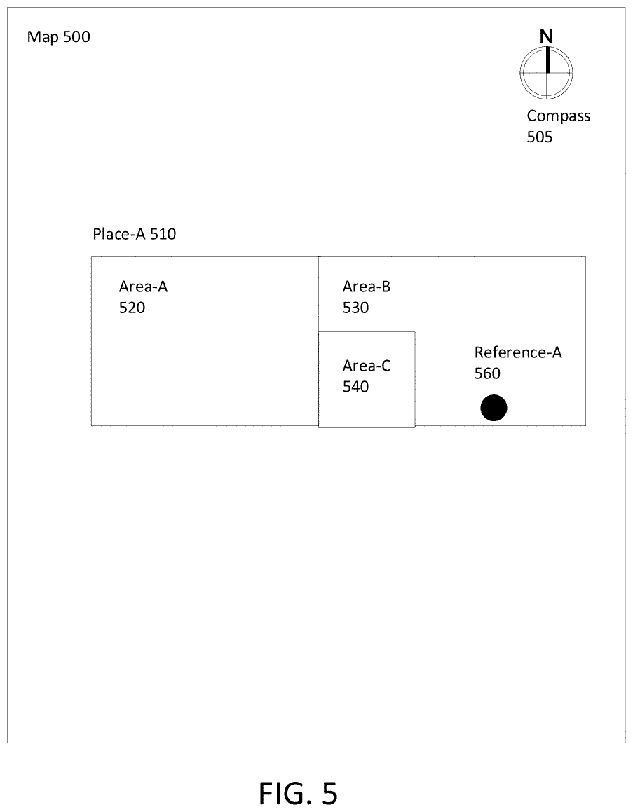

To easily locate the Reference Point 405 in FIG. 4 so that a user can start the Augmented Reality view to create or view digital content attached to physical objects, this invention first creates one reference point for each Geographic Context in the Map view. A reference point is simply a text document with a name, Geographic Context, and GPS location. FIG. 5 depicts an exemplary reference point Reference-A 560 created in Area-B 530 of Place-A 510. The Reference-A 560 has a known GPS location but there is no height associated with it since a map can only represent a two-dimensional GPS location.

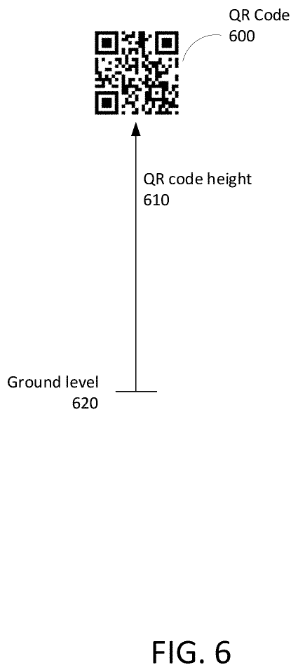

FIG. 6 demonstrates an exemplary QR Code 600 printed and affixed to a physical structure such as a door or wall. The exemplary QR Code essentially contains a text string: Place-A/Area-B/Reference-A, height. The string consists of a Geographic Path followed by an optional height in inches separated by a comma. The Geographic Path consists of a reference point name Reference-A and the Geographic Context (Place-A/Area-B) it is in. This QR Code is printed out as a small picture, say 1-inch square, and affixed to a wall or door frame at a certain height 610 from Ground Level 620. The height of the QR code must match the height encoded in the QR code if specified. Otherwise, the height will be 55 inches by default.

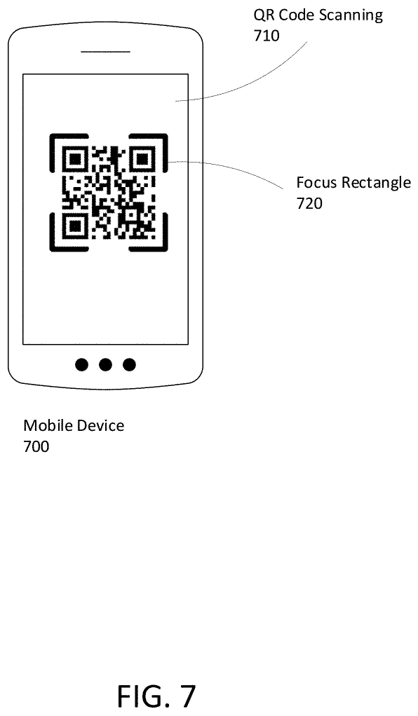

Once the QR Code is affixed to the desired location at desired height, this invention uses the user application to scan the QR code as depicted in FIG. 7. The user uses his or her mobile device 700 to position the Focus Rectangle 720 to ensure the QR code fit within its boundary and occupies at least 80% of its area. QR Code Scanning 710 produces a Geographic Path: Place-A/Area-B/Reference-A and height. The Geographic Path is used by the user application to query for the document named Reference-A under the Geographic Context Place-A/Area-B. Once the user application retrieves the document Reference-A, the application knows its associated GPS location and height. As soon as the GPS location of the QR code and height is known, the user application will start the Augmented Reality view. Since the origin of the Augmented Reality view is where the mobile device was when we scanned the QR code, the origin of Augmented Reality Coordinate System now matches the origin of the Content Coordinate System. The user application can simply query all digital content within the Geographic Context and convert all coordinates from Content Coordinate System to Augmented Reality Coordinate System. All digital content will be displayed at the same positions where they were created.

In an alternative embodiment of this invention, the QR code may simply contain the Latitude, Longitude, and height of the origin of the Content Coordinate System without using reference points. The user application can query digital content within certain distance from this origin and convert all coordinates from Content Coordinate System to Augmented Reality Coordinate System. All digital content will be displayed at the same positions where they were created.

I claim:

1. A system and method for creating and viewing digital content attached to physical objects in Augmented Reality, the system comprising: a content store for storing and indexing digital content and associated meta data such as GPS location, height, and Geographic Context; and
a web server with an Application Programming Interface (API) layer for handling requests coming from the user application; and
a user application which runs on a mobile device with GPS and Internet connection.

2. The system of claim 1, wherein the user starts Augmented Reality view by first scanning a QR code affixed to a physical structure.

3. The system of claim 2, wherein the position of the QR code is used as origin of Augmented Reality view.

4. The system of claim 1, wherein the user application facilitates the creation of reference points, which are tagged with GPS location and Geographic Context.

5. The system of claim 2, wherein the QR code can represent a reference point and height above ground level.

6. The system of claim 1, wherein the user application allows a user to touch any physical object at any height in Augmented Reality view to create digital content that attaches to the physical object of interest.

7. The system of claim 6, wherein the user application allows a user to view digital content attached to physical objects within a Geographic Context in Augmented Reality view.
